(19) United States
(12) Patent Application Publication
(10) Pub. No.: US 2009/0076635 A1
(43) Pub. Date: Mar. 19, 2009

(54) Digital Music System

(76) Inventor: Charles Key, Valencia, CA (US)

Correspondence Address: HARSHAW RESEARCH, INC., 210 W. TECUMSEH STREET, OTTAWA, KS, 66067, US

(21) Appl. No.: 11/854,651

(22) Filed: Sep. 13, 2007

(51) Int. Cl. G06F 17/00

(52) U.S. Cl. 700/94

(57) ABSTRACT

A digital music system includes a first unit (e.g. a home unit) having a processor in communication with a memory device for storing music files. The first unit includes an input device for receiving a compact disc such that music files from the disc may be stored to memory if not found there already. A second unit (e.g. portable or vehicle unit) has a similar construction. The units may communicate by direct or wireless connection for synchronizing music libraries, but only if each unit shares an identical PIN such that copyright violations are avoided. The system includes an online depository for communication with other system units for storing music libraries associated with each PIN. The depository may be accessed by wireless internet connection. The depository enables users to backup their libraries or to synchronize a saved library with a new or existing unit that is associated with a respective PIN.

### BACKGROUND OF THE INVENTION

This invention relates generally to audio electronic devices and, more particularly, to a digital music system for recording and storing digital music files from compact discs or radio programming. The present invention may include a home unit, a car unit, a portable unit, and an internet depository that are capable of synchronizing with one another.

Consumers who wish to listen to music while away from their home stereo or vehicle often utilize an mp3 digital music player. The digital music player may be connected to a computer, a compact disc may be inserted into the computer's CD player, and the music tracks of the CD may be copied to the music player's memory. This procedure is difficult, of course, for individuals who are not computer savvy or do not have access to a computer. Allowing CD's to be shared and copied also raises potential copyright law violations.

Although assumably effective for their intended purposes, digital music players require that listeners listen to their music library with headphones or to be connected to a stereo through a special interface. In other words, the music library is not transferable or transmittable between a user's home stereo and vehicle stereo. In addition, the music library is not backed up in case of a technical failure of the music player or if it is lost or stolen.

Therefore, it would be desirable to have a digital music system that enables a user to record and store music from their legally purchased CD's or radio without the use of a computer. Further, it would be desirable to have a digital music system that enables a user to transfer a digital music library from a home unit to a car unit or portable unit. In addition, it would be desirable to have a digital music system that may synchronize the home, vehicle, or portable units and that may backup the library to a central depository using the internet.

### SUMMARY OF THE INVENTION

Accordingly, a digital music system according to the present invention includes a first unit having a processor in data communication with a memory device having a plurality of music files and a music file index. The first unit processor is also in communication with an audio output device, a music input device, and a data input device. The first unit may be a home unit, vehicle unit, or portable unit. The digital music system may also include one or more second units having a similar construction. In other words, if the first unit is a home unit, then a second unit may be a vehicle or portable unit. A music compact disc may be inserted into a unit and, if one or more of the music files are not found saved on the unit, those files will be copied to the unit's memory. It is understood that digital data from a radio broadcast may also be recorded to the unit's memory in a similar manner.

Each unit is associated with a personal identification number (PIN) such that any file sharing between the units is verified and authorized. Accordingly, the first unit may transfer a music file from its memory device to the memory device of the second unit after matching the first unit PIN with the second unit PIN and determining that the second unit's memory device does not have an equivalent to a first unit music file. The second unit may transfer a music file to the first unit in a similar manner. For example, music files may be copied onto the home unit by inserting a compact disc into the unit, the unit's processor determining if the music files are already in memory and, if not, reading the files into memory. By connecting the home unit to a portable unit, stored music files that are not on a respective unit may be copied to the other. The portable unit may later be connected to a vehicle unit and a similar synchronization may occur. Copying music files in this way, however, is only permitted if each connected unit shares the same predetermined personal identification number (PIN). The unit may also include a radio tuner and radio broadcast data may be similarly copied into memory and shared between units having matching PINs.

The digital music system may also include a central depository for storing a user's music library separate from the home, vehicle, or portable units. The depository may be accessible through a wireless network, such as an internet wireless network. As with communication between home, vehicle, or portable units, each user of the depository is associated with a predetermined PIN. For example, once the PIN of a user's home unit is matched with a depository PIN, the depository may determine if there are music files on the memory device of the home unit that are not found in the depository memory device associated with that PIN or vice versa. Then, appropriate file transfers may be carried out to synchronize the libraries. This central depository is especially advantageous for instances where one or more of a user's music devices, e.g. home unit, vehicle unit, or portable unit have become inoperable, lost, or stolen and a replacement or otherwise new device has been obtained. Rather than having to reinsert and “rip” each CD again, the depository is available to reconstruct the library.

The digital music system also includes wireless internet connection capability. In other words, each unit of the system may be connected to the internet when positioned in a wireless “hotspot.” This feature enables the portable unit to access the depository from many locations. Further, a digital music unit may search for other digital music units online and, if PIN's are matched, synchronize music libraries with respective other units. This is especially advantageous as it would allow a vehicle unit to synchronize with a home unit via a wireless internet connection rather than to require a USB connection.

Therefore, a general object of this invention is to provide a digital music system for recording, storing, and listening to digital music files without the use of a computer.

Another object of this invention is to provide a digital music system, as aforesaid, that enables a user to quickly and easily copy digital music files from a home unit to a portable or vehicle unit.

Still another object of this invention is to provide a digital music system, as aforesaid, that enables music libraries to be synchronized between multiple digital music systems owned by the same person.

Yet another object of this invention is to provide a digital music system, as aforesaid, in which each digital music system unit includes a personal identification code that may be verified between communicating units and must be matched before music files may be shared.

A further object of this invention is to provide a digital music system, as aforesaid, in which digital music system units may be interconnected with a USB or wireless internet connection.

A still further object of this invention is to provide a digital music system, as aforesaid, in which song titles, artist names, etc. may be organized into playlists.

A particular object of this invention is to provide a digital music system, as aforesaid, having a user-friendly user interface.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a second/portable unit of a digital music system according to a preferred embodiment of the present invention;

FIG. 2 is a perspective view of a first/home unit of a digital music system according to the preferred embodiment of the present invention;

FIG. 3a is a perspective view of a portable unit;

FIG. 3b is a perspective view of the portable unit from another angle as in FIG. 3a;

FIG. 4 is a perspective view of the first/home unit as in FIG. 2 connected to the portable unit as in FIG. 3a;

FIG. 5 is a perspective view of another digital music system second/portable unit;

FIG. 6 is a block diagram of the digital music system;

FIG. 7 is a flowchart illustrating the features carried out by the digital music system according to the preferred embodiment of the present invention; and

FIG. 8 is a block diagram illustrating the communications between the units of the digital music system.

### DESCRIPTION OF THE PREFERRED EMBODIMENT

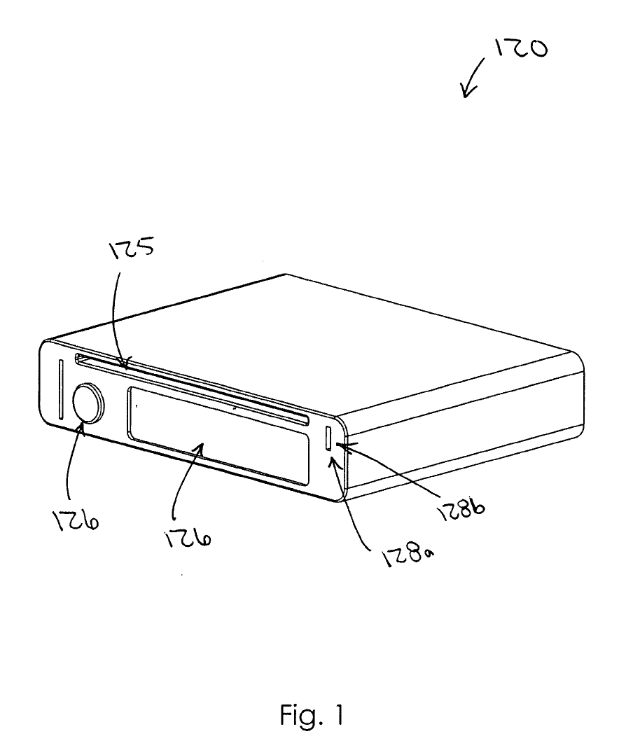

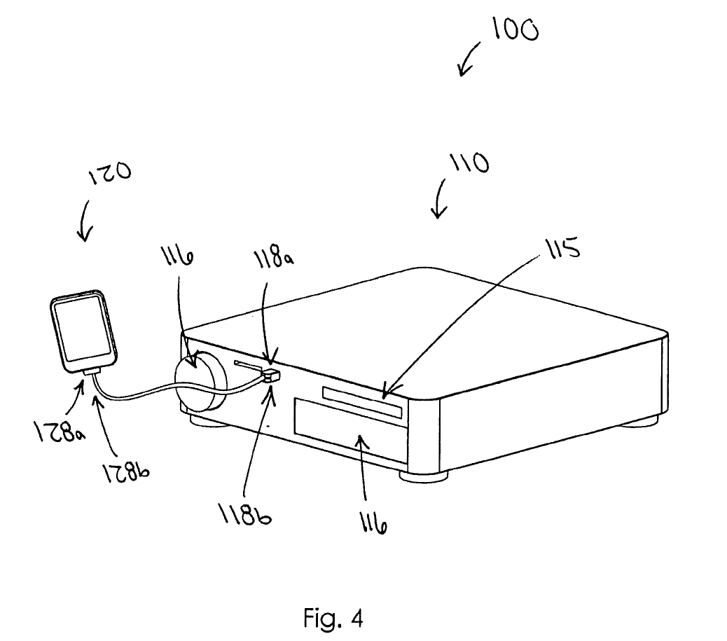

A digital music system 100 according to the present invention will now be described in detail with reference to FIGS. 1 through 8 of the accompanying drawings. More particularly, according to the current invention, a digital music system 100 includes a first unit 110.

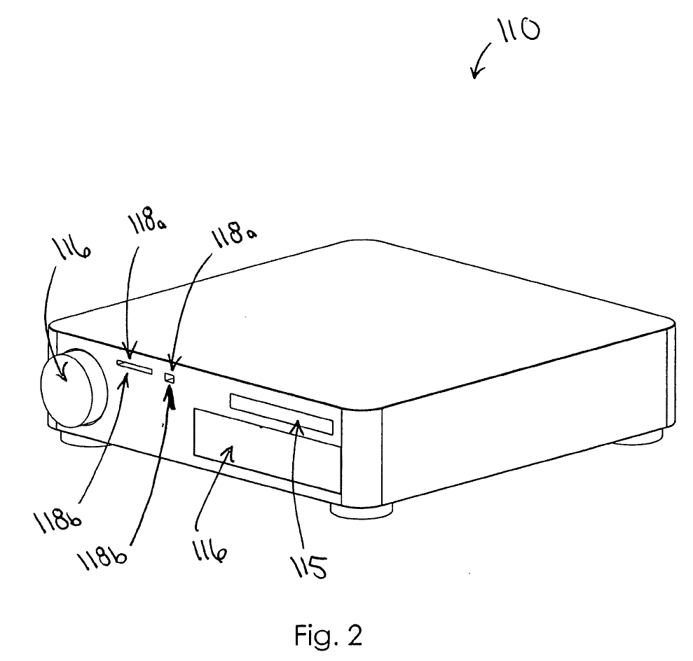

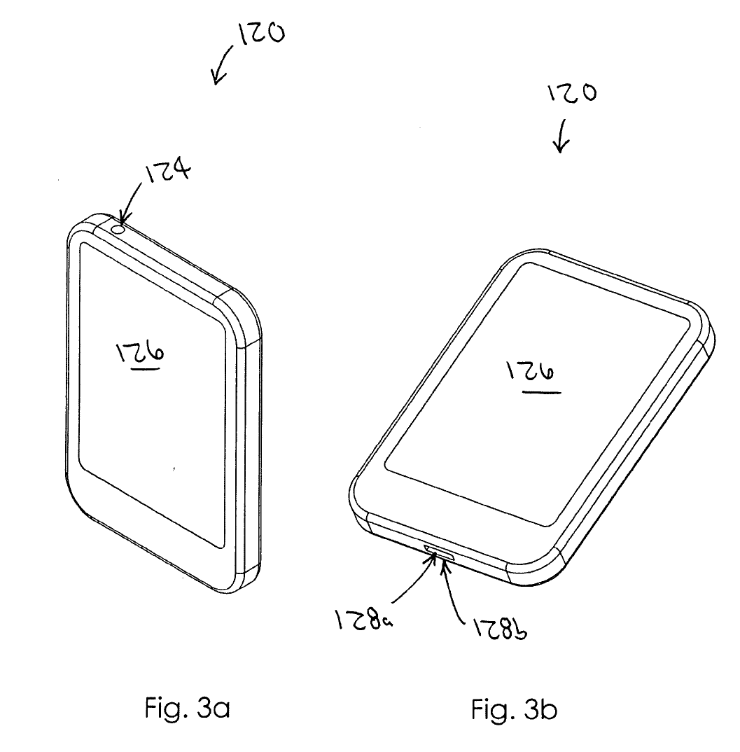

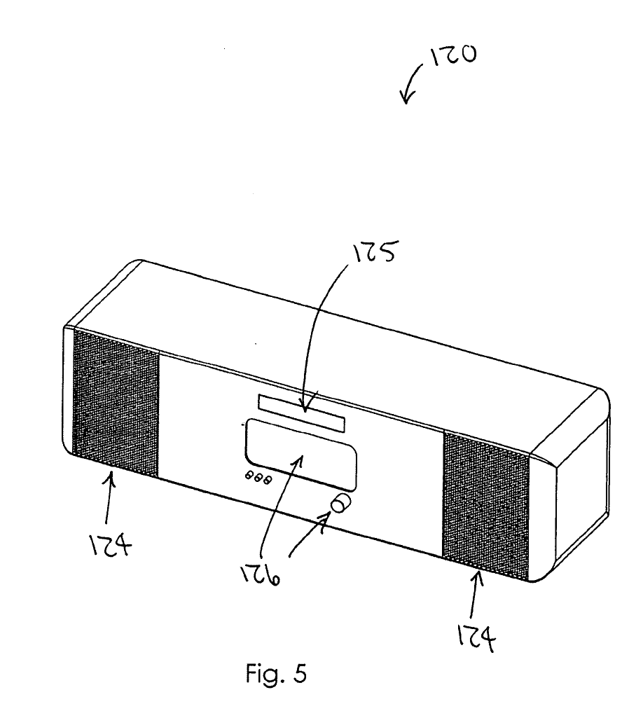

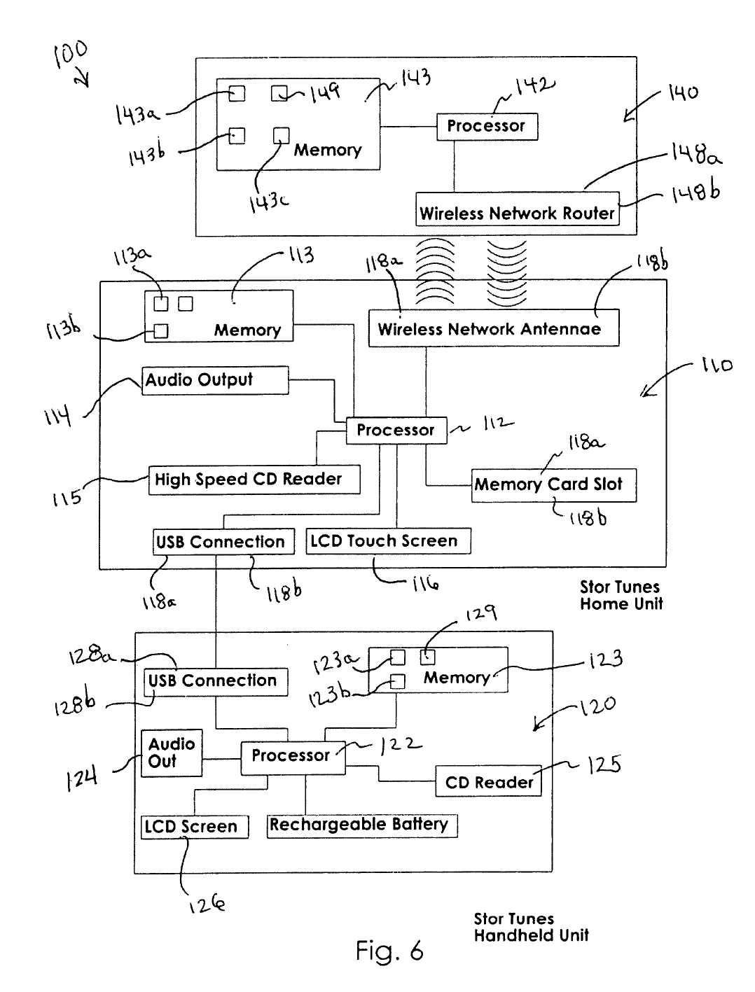

As shown in FIG. 6, the first unit 110 has a processor 112 in data communication with a memory device 113, an audio output device 114 (e.g., a speaker), a music input device 115 (e.g., a CD reader, a DVD reader, an AM/FM tuner, a satellite receiver, etc.), and a data input device 116 (e.g., a touchscreen, a knob, a switch, etc.). The memory device 113 has a plurality of music files 113a and a music file index 113b listing the music files 113a in the memory device 113. The first unit 110 may be, for example, a home unit (FIG. 2), a vehicle unit (FIG. 1), or a portable unit (FIGS. 3a, 3b, and 5). The home unit set forth in FIG. 2 is labeled as the first unit 110, though this need not be the case. A Personal Identification Number (“PIN”) 119 may be associated with the first unit 110 and may be maintained in the memory device 113 or the processor 112, for example.

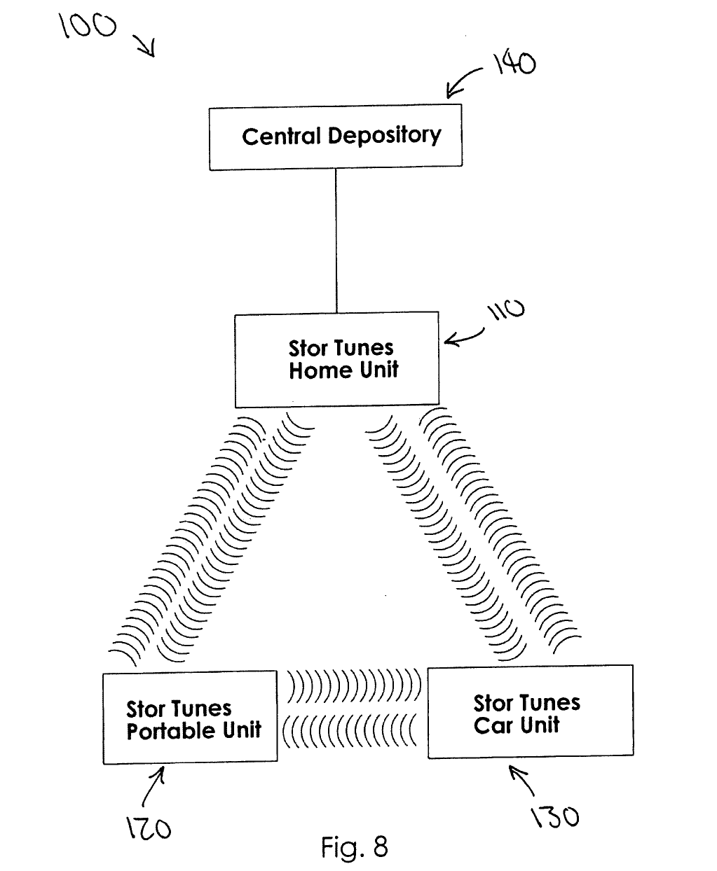

A second unit 120, as shown in FIGS. 6 and 8, may be included. The second unit 120 has a processor 122 in data communication with a memory device 123, an audio output device 124 (e.g., a speaker), and a data input device 126 (e.g., a touchscreen, a knob, a switch, a memory card etc.). The memory device 123 has a plurality of music files 123a and a music file index 123b listing the music files 123a in the memory device 123. As shown in FIG. 1, a music input device 125 (e.g., a CD reader, a DVD reader, an AM/FM tuner, a satellite receiver, etc.) may also be in data communication with the processor 122. The second unit 120 may be, for example, a home unit (FIG. 2), a vehicle unit (FIG. 1), or a portable unit (FIGS. 3a, 3b, and 5). The vehicle unit and the portable units set forth in FIGS. 1, 3a, 3b, and 5 are labeled as the second unit 120, though this need not be the case. The unit 120 shown in FIGS. 3a and 3b may be a portable unit similar to a traditional mp3 player, only it does not have need of a computer in the manner of a traditional mp3 player. A PIN 129 that corresponds to the PIN 119 may be associated with the second unit 120 and may be maintained in the memory device 123 or the processor 122, for example.

As shown in FIG. 8, a third unit 130 that is substantially similar to the first unit 110 or the second unit 120 may be included. In fact, numerous units 130 could be included in the system 100 in accordance with the disclosure and teachings set forth herein.

A depository 140 (FIG. 6) may have a processor 142 in data communication with a memory device 143 having a user file 143a with a plurality of music files 143b and a music file index 143c. A PIN 149 that corresponds to the PIN 119 may be associated with the user file 143a and may be maintained in the memory device 143 or the processor 142, for example. The depository 140 may be used by many different users, and each user may have their own user file 143a, for example. Each user of the depository has a unique associated PIN, whereby to distinguish each user's file library from any other user's file library.

Means may be included for providing a respective first unit music file 113a to the second unit memory device 123 and for providing a respective second unit music file 123a to the first unit memory device 113, or in other words, for synchronizing the music files 113a, 123a in the memory devices 113, 123. For example, the first and second units 110, 120 may include communication hardware—each including a transmitter 188a, 128a and a receiver 118b, 128b—and the second unit processor 122 may include programming for actuating the second unit communication hardware 128a to send the second unit music file index 123b and the second unit PIN 129 to the first unit communication hardware 118b. Communication hardware is referred to generically herein as “transmitter” 118a, 128a and “receiver” 118b, 128b to stress the function being performed, and may include a modem, a data port and cable, wireless transmitters and receivers, and/or any other appropriate communication hardware. The first unit 110 includes various communication hardware, as shown in FIG. 6.

The first unit processor 112 may include programming for comparing the PIN 129 sent by the second unit transmitter 128a and received by the first unit receiver 118b to the first unit PIN 119, and (only upon matching the PINs 119, 129) for comparing the first unit music file index 113b to the second unit music file index 123b. Upon determining that the second unit memory device 123 does not have an equivalent to (i.e., a copy of) a respective first unit music file 113a, the first unit processor 112 may actuate the first unit transmitter 118a to send the first unit music file(s) 113a absent from the second unit music file index 123b to the second unit receiver 128b. It should be understood that only copies of the music files 113a are sent, and that the music files 113a also remain in the first unit memory device 123. Upon determining that the first unit memory device 113 does not have an equivalent to (i.e., a copy of) a respective second unit music file 123a, the first unit processor 112 may actuate the first unit transmitter 118a to send a request for the second unit music files 123a absent from the first unit music file index 113b.

The second unit processor 122 may include programming to actuate the second unit memory device 123 to store each first unit music file 113a sent by the first unit transmitter 118a and received by the second unit receiver 128b and programming to update the second unit music file index 123b to reflect the addition of any new music files. The first unit music files 113a stored in the second unit memory device 123 are “second unit music files 123a” according to the terminology used herein. The second unit processor 122 may also include programming to actuate the second unit transmitter 128a to send any second unit music files 123a absent from the first unit music file index 113b. Programming may cause the first unit processor 112 to actuate the first unit memory device 113 to store each second unit music file 123a sent by the second unit transmitter 128a and received by the first unit receiver 118b, and the first unit processor 112 may include programming to update the first unit music file index 113b to reflect the addition of any new music files.

Means may be included for providing a respective first unit music file 113a to the depository user file 143a and for providing a respective depository music file 143b to the first unit memory device 113, or in other words, for synchronizing the music files 113a, 143b in the memory devices 113, 143. For example, the first unit processor 112 may include programming for actuating the first unit transmitter 118a to send the first unit music file index 113b and the first unit PIN 119 to a depository receiver 148b.

The depository processor 142 may include programming for comparing the PIN 119 sent by the first unit transmitter 118a and received by the depository receiver 148b to the user file PIN 149, and (only upon matching the PINs 119, 149) for comparing the first unit music file index 113b to the depository music file index 143c. Upon determining that the first unit memory device 113 does not have an equivalent to (i.e., a copy of) a respective depository music file 143b, the depository processor 142 may actuate a depository transmitter 148a to send the depository music file(s) 143b absent from the first unit music file index 113b to the first unit receiver 118b. It should be understood that only copies of the music files 143b are sent, and that the music files 143b also remain in the depository memory device 143. Upon determining that the depository memory device 143 does not have an equivalent to (i.e., a copy of) a respective first unit music file 113a, the depository processor 142 may actuate the depository transmitter 148a to send a request for the first unit music files 113a absent from the depository music file index 143c.

As shown in FIG. 6, it is understood that the depository transmitter 148a and depository receiver 148b may be wireless network router such that the depository 140 may be accessed through the internet. In this way and since a user's music library is associated with a verifiable PIN, a user who has obtained a new home unit 110 or portable unit 120 can easily synchronize with the depository 140 to obtain their entire library on the new unit. By comparing the PINs, unauthorized sharing of copyrighted music is avoided. Further, a digital music system according to the present invention may search for other digital music systems on the wireless network. If the PINs are then matched (i.e. if the units that are communicating together on the internet are owned by the same user), then the respective memory devices may be synchronized over the internet in a manner substantially similar to that described previously.

The first unit processor 112 may include programming to actuate the first unit memory device 113 to store each depository music file 143b sent by the depository transmitter 148a and received by the first unit receiver 118b and programming to update the first unit music file index 113b to reflect the addition of any new music files as discussed previously. The depository music files 143b stored in the first unit memory device 113 are “first unit music files 113a” according to the terminology used herein. The first unit processor 112 may also include programming to actuate the first unit transmitter 118a to send any first unit music files 113a absent from the depository music file index 143c. Programming may cause the depository processor 142 to actuate the depository memory device 143 to store each first unit music file 113a sent by the first unit transmitter 118a and received by the depository receiver 148b, and the depository processor 142 may include programming to update the depository music file index 143c to reflect the addition of any new music files.

Means for synchronizing the music files 123a, 143b in the second unit 120 and the depository 140 may be included that are substantially similar to the means set forth above for synchronizing the music files 113a, 143b in the first unit 110 and the depository 140. Additionally, or alternately, the second unit music files 123a may be synchronized with the depository music files 143b by synchronizing the first unit 110 with the depository 140 and then synchronizing the second unit 120 with the first unit 110. It should be appreciated that the music files 113a, 123a, 143b may be grouped in the respective memory devices 113, 123, 143 to form playlists, or that additional playlist files may be included that can be synchronized as generally set forth above.

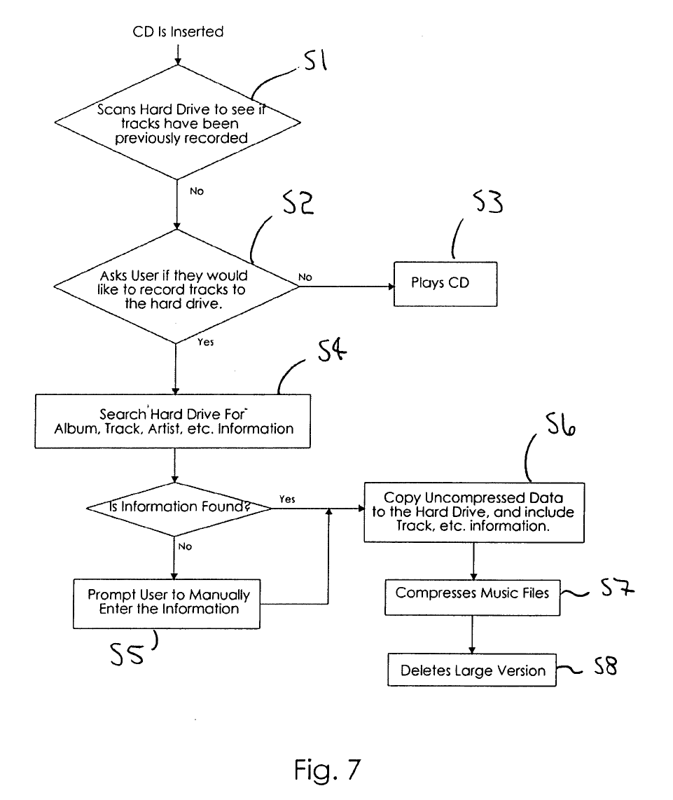

FIG. 7 shows various functions that may be performed by the system 100. For example, a music source (e.g., a CD, DVD, radio signal, etc.) may be provided to the first unit music input device 115, and at step S1 the first unit processor 112 may actuate the music input device 115 to obtain a respective music file from the music source and review the first unit music file index 113b to determine if the music file from the music source is stored in the first unit memory device 113. At step S2, if the music file is not stored in the first unit memory device 113, the processor 112 may inquire (e.g., using the audio output device 114, a display, etc.) as to whether the user would like to add the music file to the first unit memory device 113. If the answer provided by the user (such as through the data input device 116) is “no”, the processor 112 may actuate the audio output device 114 to audibly present the music file from the music source or a music file 113a from the first unit memory device 113 at step S3. If the answer provided by the user is “yes”, the processor 112 may obtain title information for each respective music file from the music input device 115 at step S4. If the information is found, the processor 112 may proceed to step S6; if not, the processor 112 may allow the information to be manually input using the data input device 116 at step S5. The title information may be associated with the respective music files 113a in the first unit memory device 113 and used in the first unit music file index 113b.

At step S6, the processor 112 may actuate the first unit memory device 113 to store the music file from the music source obtained by the music input device 115. To speed the copying process, uncompressed data may be stored at step S6, compressed music files may be created at step S7, and the originally-stored uncompressed data may be deleted at step S8. Other methods of storing the music file may also be appropriate. It is understood that the respective input devices may be utilized by a user to establish or organize playlists and the like.

It is understood that while certain forms of this invention have been illustrated and described, it is not limited thereto except insofar as such limitations are included in the following claims and allowable functional equivalents thereof.

1. A digital music system, comprising:
a first unit having a processor in data communication with: a memory device having a plurality of music files and a music file index, an audio output device, a music input device, a data input device, a transmitter, and a receiver;
a depository having a processor in data communication with: a memory device having a user file with a plurality of music files and a music file index, a transmitter, and a receiver; and
a PIN associated with said first unit and said user file;
wherein said first unit processor includes programming for actuating said first unit transmitter to send said first unit music file index and said PIN to said depository receiver;
wherein said depository processor includes programming for:
comparing said PIN received by said depository receiver to said user file PIN;
only upon matching said PIN received by said depository receiver to said user file PIN, comparing said first unit music file index to said depository music file index;
actuating said depository transmitter to send a request for any first unit music files absent from said depository music file index; and
actuating said depository transmitter to send any depository music files absent from said first unit music file index; and
wherein said first unit processor further includes programming for:
actuating said first unit memory device to store each said depository music file sent by said depository transmitter and received by said first unit receiver;
updating said first unit music file index; and
actuating said first unit transmitter to send any first unit music files absent from said depository music file index.

2. The system as in claim 1, wherein said depository processor further includes programming for:
actuating said depository memory device to store each said first unit music file sent by said first unit transmitter and received by said depository receiver in said user file; and
updating said depository music file index.

3. The system as in claim 2, wherein said first unit processor further includes programming for:
actuating said music input device to obtain a respective music file from a music source; and
actuating said first unit memory device to store said music file obtained by said music input device.

4. The system as in claim 3, further comprising:
a second unit having a processor in data communication with: a memory device having a plurality of music files and a music file index, an audio output device, a data input device, a transmitter, and a receiver;
wherein said PIN is associated with said second unit;
wherein said second unit processor includes programming for actuating said second unit transmitter to send said second unit music file index and said PIN to said first unit receiver;
wherein said first unit processor further includes programming for:
comparing said PIN sent by said second unit transmitter and received by said first unit receiver to said first unit PIN;
only upon matching said PIN received by said first unit receiver to said first unit PIN, comparing said second unit music file index to said first unit music file index;
actuating said first unit transmitter to send a request for any second unit music files absent from said first unit music file index; and
actuating said first unit transmitter to send any first unit music files absent from said second unit music file index; and
wherein said second unit processor further includes programming for:
actuating said second unit memory device to store each said first unit music file sent by said first unit transmitter and received by said second unit receiver;
updating said second unit music file index; and
actuating said second unit transmitter to send any second unit music files absent from said first unit music file index.

5. The system as in claim 4, wherein said first unit processor further includes programming for actuating said first unit memory device to store each said second unit music file sent by said second unit transmitter and received by said first unit receiver.

6. The system as in claim 5, wherein:
said first unit is one of a home unit, a vehicle unit, and a portable unit; and
said second unit is another of a home unit, a vehicle unit, and a portable unit.

7. The system as in claim 3, further comprising:
a second unit having a processor in data communication with: a memory device having a plurality of music files and a music file index, an audio output device, a data input device, a transmitter, and a receiver;
wherein said PIN is associated with said second unit;
wherein said second unit processor includes programming for actuating said second unit transmitter to send said second unit music file index and said PIN to said depository receiver;
wherein said depository processor further includes programming for:
comparing said PIN sent by said second unit transmitter and received by said depository receiver to said user file PIN;
only upon matching said PIN received by said depository receiver to said user file PIN, comparing said second unit music file index to said depository music file index;
actuating said depository transmitter to send a request for any second unit music files absent from said depository music file index; and
actuating said depository transmitter to send any depository music files absent from said second unit music file index; and
wherein said second unit processor further includes programming for:
actuating said second unit memory device to store each said depository music file sent by said depository transmitter and received by said second unit receiver;
updating said second unit music file index; and
actuating said second unit transmitter to send any second unit music files absent from said depository music file index.

8. The system as in claim 7, wherein said depository processor further includes programming for actuating said depository memory device to store each said second unit music file sent by said second unit transmitter and received by said depository receiver in said user file.

9. The system as in claim 1, wherein said first unit processor further includes programming for:
actuating said music input device to obtain a respective music file from a music source; and
actuating said first unit memory device to store said music file obtained by said music input device.

10. The system as in claim 1, wherein said first unit processor further includes programming for:
actuating said music input device to obtain a respective music file from a music source; and
actuating said audio output device to audibly present at least one of said music file obtained by said music input device and a respective music file in said first unit memory device.

11. The system as in claim 1, wherein said first unit processor further includes programming for obtaining title information for each respective music file in said first unit memory device from at least one of said music input device and said data input device, said title information being associated with respective music files in said first unit memory device and being used in said first unit music file index.

12. A digital music system, comprising:
a first unit having a processor in data communication with: a memory device having a plurality of music files and a music file index, an audio output device, a music input device, and a data input device;
a depository having a processor in data communication with a memory device having a user file with a plurality of music files and a music file index;
a PIN associated with said first unit and said user file; and
means for providing a respective first unit music file to said user file and for providing a respective depository music file to said first unit memory device after: matching said first unit PIN with said depository PIN, determining said user file does not have an equivalent to said respective first unit music file, and determining said first unit memory device does not have an equivalent to said respective depository music file.

13. The system as in claim 12, wherein said first unit is one of a home unit, a vehicle unit, and a portable unit.

14. The system as in claim 12, wherein said first unit processor includes programming for obtaining title information for respective music files in said first unit memory device from at least one of said music input device and said data input device, said title information being associated with respective music files in said first unit memory device and being used in said first unit music file index.

15. The system as in claim 12, further comprising:
a second unit associated with said PIN and having a processor in data communication with: a memory device having a plurality of music files and a music file index, an audio output device, and a data input device; and
means for providing a respective first unit music file to said second unit memory device and for providing a respective second unit music file to said first unit memory device after: matching said first unit PIN with said second unit PIN, determining said second unit memory device does not have an equivalent to said respective first unit music file, and determining said first unit memory device does not have an equivalent to said respective second unit music file.

16. The system as in claim 15, wherein:
said first unit is one of a home unit, a vehicle unit, and a portable unit; and
said second unit is another of a home unit, a vehicle unit, and a portable unit.

17. The system as in claim 16, wherein said first unit processor further includes programming for obtaining title information for respective music files in said first unit memory device from at least one of said music input device and said data input device, said title information being associated with respective music files in said first unit memory device and being used in said first unit music file index.

18. A digital music system, comprising:
a first unit having a processor in data communication with: a memory device having a plurality of music files and a music file index, an audio output device, a music input device, and a data input device;
a second unit having a processor in data communication with: a memory device having a plurality of music files and a music file index, an audio output device, and a data input device;
a PIN associated with said first unit and said second unit; and
means for providing a respective first unit music file to said second unit memory device and for providing a respective second unit music file to said first unit memory device after: matching said first unit PIN with said second unit PIN, determining said second unit memory device does not have an equivalent to said respective first unit music file, and determining said first unit memory device does not have an equivalent to said respective second unit music file.

19. The system as in claim 18, wherein:
said first unit is one of a home unit, a vehicle unit, and a portable unit; and
said second unit is another of a home unit, a vehicle unit, and a portable unit.

20. The system as in claim 19, wherein said first unit processor includes programming for obtaining title information for respective music files in said first unit memory device from at least one of said music input device and said data input device, said title information being associated with respective music files in said first unit memory device and being used in said first unit music file index.
